(19) United States
(12) Patent Application Publication
(10) Pub. No.: US 2017/0181451 A1
(43) Pub. Date: Jun. 29, 2017

(54) Novel Dye and Aroma System for Plant and Plant Product Enhancement

(71) Applicant: David Abecassis, Huntington Station, NY (US)

(72) Inventor: David Abecassis, Huntington Station, NY (US)

(73) Assignee: David Abecassis, Huntington Station, NY (US)

(21) Appl. No.: 14/983,258

(22) Filed: Dec. 29, 2015

(51) Int. Cl. A23L 1/27; C09B 13/00

(52) U.S. Cl. CPC A23L 1/2751; A23L 1/221

(57) ABSTRACT

A formulation consisting of a food-grade dye and a plant aroma cocktail is uptaken by plants and flowers and fruit. The improved aroma profile and color make the plant or it's flowers or it's fruit more desirable for consumption or viewing with an enhanced aroma.

### FIELD OF THE INVENTION

The field of the invention is biochemical plant technologies.

### BACKGROUND OF THE INVENTION

Plants are both at the base of the food chain, and a key component of human diets, as well as the basis for gardens and decorative uses of plants. Agriculture and gardening are the largest industries in many areas of the world. The economic value of plants as flavor imparting elements in human diets are well illustrated by the spice trade of the seventeenth and eighteenth centuries, when spices like pepper from India were so sought after that the market value was worth the equivalent weight in silver at that time.

Wine is another example of how fruit and vegetable derived products gain value by the quality of their appearance and their aroma.

Humans, like most primates, have highly evolved visual senses which allow us to distinguish colors. This is found in primates due to our dependence on plant derived fruits and vegetables in our diet and the importance of ripening in plant product nutrition and flavor in this selection process of what gets chosen to be eaten.

Plants have evolved elaborate colors and aromas in a deliberate evolutionary effort to make their fruit more attractive to animals, and thus inducing the animals to consume the fruiting bodies of the plants, along with the seeds, and thus spreading the plants descendants.

In particular, plants produce a variety of colors and aromas which enhance these attractive qualities to animals and thus humans.

Most food flavors, including most meat based dishes, derive the majority of their perceived flavor from small molecules which vaporize in the mouth cavity and then migrate into the sinuses where most of the flavor is detected by nerve receptors which account for most complex and subtle flavors.

Most plants and fruits which are edible, derive their flavors from a few hundred compounds, which in different combinations, account for most of the flavors we recognize in almost all of the foods and beverages we consume.

In cooking, this effect is maximized with emphasis placed both on how these flavors can be directed in recipes, as well as how beverages such as wine can add to the aroma profile as the food is consumed.

### OBJECTS OF THE INVENTION

One object of the invention is to develop a simultaneous aroma and color additive for uptake by plants. Another object of the invention is the improvement of flowers and fruiting bodies in plants. Yet another object of the invention is to develop new artificially created flavors and appearances in fruits and flowers.

### SUMMARY OF THE INVENTION

The invention is a combination of aromas and dyes or natural colored compounds which are food-grade and suitable for uptake by plants without interfering with plant metabolism, which can be take through roots, or injected into plants, or introduced through the vascular system of the plant through a variety of standard means, such as uptake by cuttings.

### DETAILED DESCRIPTION OF THE INVENTION

The invention is an aqueous blend of complex food-grade plant aromas and a food-grade coloring compound which is introduced into the plant vascular system either by root, stem, flower, or fruit uptake.

### Examples

A mixture of inalool and methylchavicol and 1,8-cineole and eugenol in equal ratios is mixed with water at twenty percent volume per volume and then mixed with an additional twenty percent of food grade phycocyanine solution and completed to one hundred parts with water. The solution is then fed to hydroponically grown strawberries, which have had the tips of their roots severed to decrease selective permeability by the roots. During the application process polyethylene film is temporarily placed over the hydroponic solution to decrease volatile evaporation during plant uptake. the resulting strawberry has a purple or violet visual appearance, and an extraordinary aroma and flavor due to the mixing of the basil aroma molecules with the strawberry's own aromas such as beta-ionine and furanone. This is one preferred embodiment of the invention. in another preferred embodiment of the invention, fruiting vegetable plants such as squash are cut at their base, at harvest time, and the stem placed in a vase containing trans-cinnamic acid dissolved with small thiol compounds, which impart an earthy or mushroom like flavor, with allicin the molecule which imparts flavor to garlic and onions. This solution is mixed with chlorophyllin and completed to the total final volume.

The uptake of this solution by the squash results in a green appearance which is enhanced along with a greatly improved flavor without requiring other ingredients at the time of harvest.

In another preferred embodiment, cannabis sativa or cannabis indica are injected with, or cut at the base to uptake, a solution of phycocyanin and a complex extract of blueberry derived aroma compounds which number ninety one different individual compounds which make up blueberry flavor.

The cannabis plant is placed in a large vase which allows uptake of the coloring aroma solution without significant loss of volatile components. The process is carried out at the time of harvest allowing between twenty four, and seventy two hours for uptake. The resulting cannabis buds are more fragrant and more attractive visually.

In another preferred embodiment, tomatoes are injected with tiny syretts containing allicin, to impart a garlic-onion like flavor as well as the compound betanin which is a natural food color derived from beets.

The syrette is left in the tomato until it is harvested and then removed, allowing for the fruit to take up the aroma and the plant derived food dye simultaneously.

1) A food grade dye or plant derived coloration combined with a small-molecule aromatic cocktail to induce both appearance and aroma profile of plant flowers and fruits by uptake into the plant.

2) A food grade dye or plant derived coloration combined with a small-molecule aromatic cocktail to induce both appearance and aroma profile selectively for flowers by uptake into the plant.

3) A food grade dye or plant derived coloration combined with a small-molecule aromatic cocktail to induce both appearance and aroma profile of plant vegetative parts by uptake into the plant.

4) The claims in 1 where the aroma molecule is derived from natural plant aroma purification and concentration.

5) The claim in 2 where the aroma profile is derived from natural plant aroma purification and concentration.

6) The claim in 1 where the dye is synthetic yet food grade and fit for food consumption in animals and humans.
